(19) United States
(12) Patent Application Publication
(10) Pub. No.: US 2025/0092486 A1
(43) Pub. Date: Mar. 20, 2025

(54) SACRIFICIAL METAL BASED RADIOLYSIS MITIGATION DURING CHROMATOGRAPHIC SEPARATION OF RADIOISOTOPES

(71) Applicant: SHINE Technologies, LLC, Janesville, WI (US)

(72) Inventor: Abdul Momen, Janesville, WI (US)

(21) Appl. No.: 18/884,465

(22) Filed: Sep. 13, 2024

Related U.S. Application Data
(60) Provisional application No. 63/538,706, filed on Sep. 15, 2023.

(51) Int. Cl. C22B 3/42; C22B 3/22; C22B 59/00

(52) U.S. Cl. CPC C22B 3/42; C22B 3/22; C22B 59/00

(57) ABSTRACT

Provided herein methods of purifying a chemical element (e.g. radioisotope) involving the use of sacrificial metal dopants and/or radical scavengers during chromatographic separation of the desired element, thereby mitigating undesirable radiolysis.

### PRIORITY STATEMENT

This application claims priority to U.S. Provisional Application No. 63/538,706, filed Sep. 15, 2023, the entire contents of which are incorporated herein by reference for all purposes.

### FIELD

Provided herein are methods for purifying a chemical element that minimize radiolysis of the desired element during purification. In particular, provided herein are methods of purifying a chemical element involving the use of sacrificial metal dopants and/or radical scavengers during chromatographic separation of the desired element, thereby mitigating undesirable radiolysis.

### BACKGROUND

Radioisotopes such as lutetium-177 (Lu-177) find use in various diagnostic and treatment methods, including for cancer. Current methods of separating radioisotopes are subject to radiolysis of the radioisotope during the separation process. Accordingly, a need exists for improved technologies of purifying radioisotopes, such as Lu-177, that minimize radiolysis.

### SUMMARY

According to a first aspect of the present disclosure, a method of purifying a chemical element comprises subjecting a composition comprising the chemical element and one or more impurities to sublimation, distillation, or chromatography, thereby removing at least a portion of the one or more impurities from the composition to obtain a semi-purified sample; adding a metal dopant to the semi-purified sample; and subjecting the semi-purified sample containing the metal dopant to chromatographic separation to remove the metal dopant and other impurities, thereby obtaining a sample fraction enriched in the chemical element.

A second aspect includes the method of the first aspect, wherein the metal dopant comprises a lanthanide.

A third aspect includes the method of the first aspect or the second aspect, wherein the metal dopant comprises lanthanum, cerium, praseodymium, neodymium, promethium, samarium, europium, gadolinium, terbium, dysprosium, holmium, erbium, thulium, ytterbium, or a salt thereof.

A fourth aspect includes the method of any of the previous aspects, wherein the metal dopant is chelated.

A fifth aspect includes the method of any of the previous aspects, wherein the amount of the metal dopant added to the semi-purified sample exceeds the amount of the chemical element in the sample.

A sixth aspect includes the method of any of the previous aspects, wherein the method further comprises chelating the semi-purified sample comprising the metal dopant prior to the chromatographic separation, and de-chelating the sample fraction enriched in the chemical element following the chromatographic separation.

A seventh aspect includes the method of any of the previous aspects, wherein the chromatographic separation comprises high performance liquid chromatography (HPLC).

An eighth aspect includes the method of any of the previous aspects, wherein the method comprises subjecting the sample fraction enriched in the chemical element to an additional chromatographic separation step to further enrich for the chemical element.

A ninth aspect includes the method of the eighth aspect, wherein the additional chromatographic separation step comprises HPLC.

A tenth aspect includes the method of any of the previous aspects, wherein the method comprises adding a radical scavenger to the sample fraction enriched in the chemical element prior to or during the additional chromatographic separation step.

An eleventh aspect includes the method of the tenth aspect, wherein the radical scavenger is ascorbic acid or a mineral salt thereof.

A twelfth aspect includes the method of the eleventh aspect, wherein the radical scavenger is sodium ascorbate.

An thirteenth aspect includes the method of any of the eighth through twelfth aspects, wherein the sample fraction enriched in the chemical element is not chelated during the additional chromatographic separation step.

A fourteenth aspect includes the method of any of the previous aspects, wherein the chemical element is a radioisotope.

A fifteenth aspect includes the method of any of the previous aspects, wherein the chemical element is lutetium.

A sixteenth aspect includes the method of the thirteenth aspect, wherein the chemical element is lutetium-177.

A seventeenth aspect includes the method of any of the previous aspects, wherein the one or more impurities comprise ytterbium.

An eighteenth aspect includes the method of the seventeenth aspect, wherein the one or more impurities comprise ytterbium-176.

A nineteenth aspect includes the method of any of the previous aspects, wherein the sublimation, distillation, or chromatography removes at least 50% of the one or more impurities from the composition.

An twentieth aspect includes the method of any of the previous aspects, wherein the sublimation, distillation, or chromatography removes at least 80% of the one or more impurities from the composition.

According to a twenty-first aspect of the present disclosure, a method of purifying a chemical element (e.g. radioisotope) comprising subjecting a composition comprising the chemical element and one or more impurities to sublimation, distillation, or chromatography, thereby removing at least a portion of the one or more impurities from the composition to obtain a semi-purified sample; subjecting the semi-purified sample to a chromatographic separation, thereby obtaining a sample fraction enriched in the chemical element; and contacting the sample fraction enriched in the chemical element with a radical scavenger and subjecting the sample fraction and the radical scavenger to an additional chromatographic separation to remove the radical scavenger and other impurities.

A twenty-second aspect includes the method of the twenty-first aspect, wherein the method comprises chelating the semi-purified sample prior to the chromatographic separation and de-chelating the sample fraction enriched in the chemical element following the chromatographic separation.

A twenty-third aspect includes the method of the twenty-first aspect or the twenty-second aspect, wherein the sample fraction containing the radical scavenger is not chelated during the additional chromatographic separation.

A twenty-fourth aspect includes the method of any of the twenty-first through twenty-third aspects, wherein the chromatographic separation comprises high-performance liquid chromatography.

A twenty-fifth aspect includes the method of any of the twenty-first through twenty-fourth aspects, wherein the additional chromatographic separation comprises high-performance liquid chromatography.

A twenty-sixth aspect includes the method of any of the twenty-first through twenty-fifth aspects, wherein the radical scavenger is ascorbic acid or a mineral salt thereof.

A twenty-seventh aspect includes the method of the twenty-sixth aspect, wherein the radical scavenger is sodium ascorbate.

A twenty-eighth aspect includes the method of any of the twenty-first through twenty-seventh aspects, wherein the chemical element is a radioisotope.

A twenty-ninth aspect includes the method of any of the twenty-first through twenty-eighth aspects, wherein the chemical element is lutetium.

A thirtieth aspect includes the method of any of the twenty-first through twenty-ninth aspects, wherein the chemical element is lutetium-177.

A thirty-first aspect includes the method of any of the twenty-first through thirtieth aspects, wherein the one or more impurities comprise ytterbium.

An thirty-second aspect includes the method of the thirty-first aspect, wherein the one or more impurities comprise ytterbium-176.

A thirty-third aspect includes the method of any of the twenty-first through thirty-second aspects, wherein the sublimation, distillation, or chromatography removes at least 50% of the one or more impurities from the composition.

An thirty-fourth aspect includes the method of any of the twenty-first through thirty-third aspects, wherein the sublimation, distillation, or chromatography removes at least 80% of the one or more impurities from the composition.

According to a thirty-fifth aspect of the present disclosure, a system comprises a composition comprising lutetium and one or more impurities; one or more chromatography resins; and a radical scavenger and/or a metal dopant.

A thirty-sixth aspect includes the system of the thirty-fifth aspect, wherein the metal dopant comprises a lanthanide.

A thirty-seventh aspect includes the system of the thirty-sixth aspect, wherein the metal dopant comprises lanthanum, cerium, praseodymium, neodymium, promethium, samarium, europium, gadolinium, terbium, dysprosium, holmium, erbium, thulium, ytterbium, or a salt thereof.

A thirty-eighth aspect includes the system of any of the thirty-fifth through thirty-seventh aspects, wherein the one or more chromatography resins comprise an anion exchange resin, a cation exchange resin, and/or a high-performance liquid chromatography resin.

A thirty-ninth aspect includes the system of any of the thirty-fifth through thirty-eighth aspects, wherein the radical scavenger is ascorbic acid or a mineral salt thereof.

A fortieth aspect includes the system of the thirty-ninth aspect, wherein the radical scavenger is sodium ascorbate.

A forty-first aspect includes the system of any of the thirty-fifth through fortieth aspects, wherein the system is contained in a hot cell.

### BRIEF DESCRIPTION OF THE DRAWINGS

FIG. 1 is a flow chart showing an exemplary method of purifying a chemical element described herein involving use of a metal dopant to confer protection against radiolytic loss of the chemical element to be purified. As shown, the method comprises subjecting a composition containing the chemical element and impurities to sublimation, distillation, or chromatography step to remove a portion of the impurities from the sample, thereby generating a semi-purified sample. Such an initial purification step is also referred to herein as stage 1. The method then comprises adding a metal dopant to the semi-purified sample, and subjecting the semi-purified sample with the metal dopant to chromatographic separation, also referred to herein as stage 2, to obtain a sample fraction enriched in the chemical element. The sample fraction can be subjected to additional chromatographic separation steps to further enrich for the chemical element.

FIG. 2 is a flow chart showing an exemplary method of purifying a chemical element described herein involving use of a radical scavenger to confer protection against radiolytic loss of the chemical element to be purified. As shown, the method comprises subjecting a composition containing the chemical element and impurities to sublimation, distillation, or chromatography step to remove a portion of the impurities from the sample, thereby generating a semi-purified sample. Such an initial purification step is also referred to herein as stage 1. The method then comprises subjecting the semi-purified sample to chromatographic separation, referred to herein as stage 2, thereby obtaining a sample fraction enriched in the chemical element. The sample can be chelated prior to the chromatographic separation (stage 2), and de-chelated following the chromatographic separation. The method then implements a radical scavenger, which can be added to the sample fraction enriched in the chemical element as shown in FIG. 2, followed by chromatographic separation. Alternatively, the radical scavenger can be present within or added directly to the chromatography resin, and the sample fraction enriched in the chemical element can be added to the resin separately, followed by chromatographic separation. Either method results in chromatographic separation of the chemical element from the radical scavenger and other remaining impurities, resulting in isolation of the purified chemical element.

FIGS. 3A-3C show representative diagrams of exemplary systems described herein comprising a composition (represented by the C) comprising a chemical element and one or more impurities, a metal dopant (represented by the D), and a chromatography resin. As shown in FIG. 3A, the system can comprise each of these components separately from one another. Arrows indicate potential steps that can be conducted during use of a system for purification of a chemical element. For example, the arrows shown in FIG. 3A indicate that the dopant can be added to the composition, which can then be added to the chromatography resin. As shown in FIG. 3B, the system can comprise a single mixture comprising the composition and the metal dopant, and a separate resin. As indicated by the arrow, such a composition can be added to the resin. As shown in FIG. 3C, the system can comprise a resin which contains the composition and the metal dopant.

FIGS. 4A-4D show representative diagrams of exemplary systems described herein comprising a composition (represented by the C) comprising a chemical element and one or more impurities, a radical scavenger (represented by the S), and a chromatography resin. As shown in FIG. 4A, the system can comprise each of these components separately from one another. Arrows indicate potential steps that can be conducted during use of a system for purification of a chemical element. For example, the arrows shown in FIG. 4A indicate that the radical scavenger can be added to the composition, which can then be added to the resin. As shown in FIG. 4B, the system can comprise a single mixture comprising the composition and the radical scavenger, and a separate resin. As shown by the arrow, such a composition can be added to the resin. As shown in FIG. 4C, the system can comprise a resin which contains the radical scavenger, and a separate composition. As shown by the arrow, the composition can be added to the resin. As shown in FIG. 4D, the system can comprise a resin which contains the composition and the radical scavenger.

FIGS. 5A, 5B, 5C, and 5D show injection activity for the injections with and without lanthanum chelate shown in Table 1.

### DEFINITIONS

Unless otherwise defined herein, scientific and technical terms used in connection with the present disclosure shall have the meanings that are commonly understood by those of ordinary skill in the art. The meaning and scope of the terms should be clear; in the event, however of any latent ambiguity, definitions provided herein take precedent over any dictionary or extrinsic definition. Further, unless otherwise required by context, singular terms shall include pluralities and plural terms shall include the singular.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical values or idealized geometric forms provided. Accordingly, these terms should be interpreted as indicating that insubstantial or inconsequential modifications or alterations of the subject matter described and claimed are considered to be within the scope of the disclosure as recited in the appended claims. In some embodiments, the terms indicate a value of +/−10% of the recited value. For example, “about” or “approximately” 1 can indicate 0.9 to 1.1, and all values included in the range therebetween.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

### DETAILED DESCRIPTION

Radioisotopes, or radionuclides, offer a valuable strategy for cancer diagnostics and therapeutics. Lu-177 is a theranostic radionuclide useful for both diagnostic testing and therapeutic treatments. Specifically, during decay Lu-177 emits a low energy beta particle that is suitable for treating cancer, including neuro endocrine tumors, prostate, breast, renal, pancreatic, and other cancers. Lu-177 also emits two gamma rays that can be used for diagnostic testing. In the coming years, approximately 70,000 patients per year will need no carrier added Lu-177 during their medical treatments. However, methods for purification of radioisotopes such as Lu-177 are hindered by radiolysis that occurs during the purification. The present disclosure addresses this and other issues by providing a method for purifying chemical elements that mitigates radiolysis by addition of a metal dopant and/or a radical scavenger during the purification process.

In some aspects, provided herein are methods of purifying a chemical element. As used herein, the terms “element” and “chemical element” are used interchangeably herein and refer to chemical elements along with isotopes and radioisotopes thereof. A “radioisotope”, “radionuclide, or a “radioactive isotope” refers to an isotope of an element that contains an unstable combination of neutrons and protons, or excess nuclear energy. The excess nuclear energy is emitted from the nucleus in a process known as radioactive decay. Given the radioactive nature of radioisotopes, any one of more steps of the methods for purification thereof described herein can be performed in a hot cell.

In some embodiments, the methods for purifying a chemical element provided herein involve subjecting a composition comprising the chemical element and one or more impurities to sublimation, distillation, or chromatography, thereby removing at least a portion of the one or more impurities from the composition. In some embodiments, the sublimation, distillation, or chromatography, considered the initial purification step, removes more than 50% of the one or more impurities from the composition. In some embodiments, the sublimation, distillation, or chromatography removes more than 50%, more than 60%, more than 70%, more than 80%, more than 90%, or more than 95% of the one or more impurities from the composition. In some embodiments, the sample is then subjected to one or more chromatographic separation steps in the presence of a metal dopant and/or a radical scavenger, which protect the chemical element of interest from radiolysis.

In some embodiments, the method for purifying a chemical element comprises subjecting a composition comprising the chemical element and one or more impurities to sublimation, distillation, or chromatography, thereby removing at least a portion of the one or more impurities from the composition to obtain a semi-purified sample; adding a metal dopant to the semi-purified sample; and subjecting the semi-purified sample containing the metal dopant to chromatographic separation to remove the metal dopant and other impurities, thereby obtaining a sample fraction enriched in the chemical element. Without wishing to be bound by theory, it is possible that the metal dopant acts as a sacrificial target for radiolysis, such that significant radiolysis occurs to the metal dopant while shielding the chemical element from radiolytic damage. In some embodiments, the amount of shielding (e.g. protection) from radiolysis conferred by the metal dopant to the chemical element depends on the relative amounts of the metal dopant and the chemical element present in the semi-purified sample. The amount of the metal dopant added to the semi-purified sample should be modulated to confer sufficient protection from radiolysis to the chemical element to be purified while minimizing contamination during chromatographic separation. In some embodiments, the amount of metal dopant added to the semi-purified sample exceeds the amount of the chemical element present in the semi-purified sample. In some embodiments, the amount of the metal dopant added to the semi-purified sample exceeds the amount of the chemical element present in the semi-purified sample by at least 10%. In some embodiments, the amount of the metal dopant added to the semi-purified sample exceeds the amount of the chemical element present in the semi-purified sample by at least 20%, at least 30%, at least 40%, at least 50%, at least 60%, at least 70%, at least 80%, at least 90%, or at least 100%.

Any suitable metal dopant may be used. Generally speaking, the metal dopant should be a different metal than the desired element to be purified to enable separation of the metal dopant from the element during subsequent chromatographic separation steps. In some embodiments, the metal dopant comprises a lanthanide. In some embodiments, the metal dopant comprises lanthanum, cerium, praseodymium, neodymium, promethium, samarium, europium, gadolinium, terbium, dysprosium, holmium, erbium, thulium, ytterbium, or a salt thereof. In some embodiments, the metal dopant is chelated. In some embodiments, the metal dopant is not chelated.

In some embodiments, the method further comprises chelating the semi-purified sample comprising the metal dopant prior to chromatographic separation. In some embodiments, chelating the semi-purified sample comprises dissolving the sample in an acid, adding a chelator, and neutralizing with a base. In some embodiments, the chelated semi-purified sample is then subjected to chromatographic separation, thereby removing the metal dopant (e.g. the chelated metal dopant) from the chelated element and producing a sample fraction enriched in the chemical element. In some embodiments, the method then comprises de-chelating sample fraction enriched in the chemical element. In some embodiments, de-chelating the sample fraction enriched in the chemical element comprises adding an acid to the sample.

In some embodiments, the method further comprises subjecting the sample fraction enriched in the chemical element to an additional chromatographic separation step to further enrich for the chemical element (e.g. to further remove undesired impurities). In some embodiments, the sample fraction enriched in the chemical element is not chelated during the additional chromatographic separation step. In some embodiments, the metal dopant is not added during the additional chromatographic separation step. In some embodiments, the method comprises adding a radical scavenger to the sample fraction enriched in the chemical element prior to or during the additional chromatographic separation step.

In some embodiments, provided herein is a method of purifying a chemical element comprising subjecting a composition comprising the chemical element and one or more impurities to sublimation, distillation, or chromatography, thereby removing at least a portion of the one or more impurities from the composition to obtain a semi-purified sample; subjecting the semi-purified sample to a chromatographic separation, thereby obtaining a sample fraction enriched in the chemical element; and contacting the sample fraction enriched in the chemical element with a radical scavenger and subjecting the sample fraction and the radical scavenger to an additional chromatographic separation to remove the radical scavenger and other impurities. In some embodiments, contacting the sample fraction enriched in the chemical element with a radical scavenger comprises adding the radical scavenger to the sample fraction enriched in the chemical element, and then adding the sample fraction enriched in the chemical element and containing the radical scavenger to the chromatography resin. In some embodiments, contacting the sample fraction enriched in the chemical element with a radical scavenger comprises adding the sample fraction enriched in the chemical element and the radical scavenger separately to the chromatography resin. In some embodiments, contacting the sample fraction enriched in the chemical element with a radical scavenger comprises adding the sample fraction enriched in the chemical element to a chromatography resin (e.g. column) which contains (e.g. is pre-loaded with) the radical scavenger. In some embodiments, the method comprises chelating the semi-purified sample prior to the chromatographic separation and de-chelating the sample fraction enriched in the chemical element following the chromatographic separation. In some embodiments, the sample fraction containing the radical scavenger is not chelated during the additional chromatographic separation.

In some embodiments, the methods provided herein involve adding a radical scavenger prior to or during chromatographic separation to protect the chemical element within the sample from radiolysis during purification. In some embodiments, the radical scavenger is added to the sample. For example, in some embodiments, the radical scavenger is added to the sample and the sample containing the radical scavenger is subsequently added to the resin. In some embodiments, the radical scavenger is added to the chromatography column (e.g. resin) prior to, concurrently with, or after the sample is added to the resin. In some embodiments, the radical scavenger is present within the chromatography resin, such as in dried form. The term “radical scavenger” as used herein refers to a compound that either prevents reactive oxygen species, referred to as free radicals, from being formed, or that removes them from the environment. Radical scavengers are a broad class of compounds including naturally occurring compounds and synthetic compounds. Nonlimiting examples of radical scavengers include catalases, glutathione, peroxidase, carotenoids (e.g. oxo-carotenoids), superoxide dismutase (SOD), tocopherols (e.g. alpha-tocopherol/vitamin E), ascorbic acid (vitamin C), beta-carotene (vitamin A), selenium, uric acid, bilirubin, albumin, thiols, and the like, including salts (e.g. mineral salts) thereof. Generally speaking, a radical scavenger added before one or more chromatographic separation steps should have adequate radical scavenging properties while also still being able to be separated from the chemical element of interest during the chromatographic separation. The amount of the radical scavenger added should be modulated to confer adequate protection against radiolysis, while minimizing unwanted carryover contamination into the enriched fraction following chromatographic separation. In some embodiments, the radical scavenger comprises ascorbic acid or a mineral salt thereof. In some embodiments, the radical scavenger comprises sodium ascorbate.

For any of the methods provided herein, the one or more impurities present in the composition depend on the method by which the chemical element to be purified is produced or otherwise obtained. In some embodiments, the Lu-177 to be purified is produced by a neutron capture reaction on ytterbium-176 (Yb-176). Such a neutron capture reaction produces Yb-177, which then rapidly (half-life of 1.911 hours) beta-decays into Lu-177. An impurity of Yb-174 is typically present in the Yb-176, leading to a further impurity of Lu-175 in the final product. This process is considered to be a “no carrier added” process. The process may be carried out as ytterbium metal or ytterbium oxide. In some embodiments, the purification methods provided herein are particularly useful for purification of Lu-177 from a “no carrier added” process. Accordingly, in some embodiments the composition comprises Lu-177 and one or more impurities, wherein the one or more impurities comprise ytterbium. In some embodiments, the one or more impurities comprise Yb-176. In some embodiments, the one or more impurities comprise Yb-176 and Yb-174.

In some embodiments, the method comprises subjecting the composition comprising the chemical element and one or more impurities to a sublimation or a distillation process. In some embodiments, the sublimation or distillation process is performed prior to adding the metal dopant and/or radical scavenger to the composition. Such an initial sublimation/distillation step removes a relatively large percentage of impurities prior to performing chromatographic separation, thereby limiting the amount of impurities that enter the chromatography resin. This enhances the recovery of the desired chemical element to be purified while decreasing the amount of time required for such chromatographic purification. Suitable sublimation and distillation processes, along with containers (e.g. crucibles) in which such processes can be conducted are described in PCT Publication No. WO2021202914A1, the entire contents of which are incorporated herein by reference for all purposes. In sublimation, the solid phase of an element is converted directly to the gas phase via heating, and the gas phase can then be collected for later use. In distillation, the solid is heated to its boiling point (going through the liquid phase) and vaporized off. The vaporized fraction can then be recovered downstream after the vapor is condensed. For example, ytterbium can be vaporized (and it may be collected downstream for later use), leaving behind a material that is enriched in lutetium. Generally speaking, the pressure and temperature for a sublimation or distillation reaction depends on the differences in vapor pressure between the chemical element to be purified and the one or more impurities.

In some embodiments, the composition is a solid composition comprising the chemical element and the one or more impurities. In some embodiments, the composition is a solid composition comprising lutetium and ytterbium, and the initial purification step comprises subliming or distilling ytterbium from the composition, leaving behind a semi-purified composition enriched in lutetium. For example, in some embodiments the method comprises subliming or distilling ytterbium from the composition at a temperature of about 400° C. to about 3000° C. and a pressure of about 1×10⁻⁸ torr to about 1520 torr.

In some embodiments, the methods provided herein comprise subjecting the composition comprising the chemical element and the one or more impurities to chromatography to remove a portion of the one or more impurities from the sample prior to performing subsequent chromatographic separation steps. In some embodiments, the methods provided herein comprise subjecting the composition comprising the chemical element and one or more impurities to a sublimation or distillation process to remove a portion of the one or more impurities, and subsequently subjecting the semi-purified composition obtained therefrom to one or more chromatographic separation steps. The semi-purified composition may be chelated during at least one of the one or more chromatographic separation steps. As used herein, the term “chromatography” or “chromatographic separation” refers to any type of chromatography, including, for example, column chromatography, plate chromatography, thin cell chromatography, or high-performance liquid chromatography (HPLC). Generally speaking, chromatography involves separating a mixture into its components by dissolving the mixture in a fluid solvent (e.g. a gas or a liquid) referred to as the mobile phase, which carries the mixture through a system containing a fixed material referred to as the stationary phase. The different components of the mixture have different affinities for the stationary phase, and therefore travel through the stationary phase at different rates, thus permitting separation of various components of the mixture from each other.

In some embodiments, the chromatography comprises ion exchange chromatography. Ion exchange chromatography refers to a chromatography technique that separates components in a mixture based upon their affinity for an ion exchanger. Ion exchange chromatography includes anion-exchange chromatography and cation-exchange chromatography. In cation-exchange chromatography, the stationary phase is negatively charged and positively charged molecules are attracted to it. For example, the pH at which cation-exchange chromatography is conducted may be less than the isoelectric point (pI) of the molecule of interest, as such the molecule is positively charged and is attracted to the negatively charged ions (anions) on the stationary phase. Alternatively, for anion-exchange chromatography the stationary phase is positively charged and negatively charged molecules are attracted to it. For example, the pH at which in anion-exchange chromatography is conducted may be greater than the isoelectric point of the molecule of interest, such that the molecule of interest carries a negative charge and is attracted to the positively charged ions (cations) on the stationary phase. Cation exchange or anion exchange chromatography may be conducted by adding a suitable acid or base to the composition comprising the chemical element and the one or more impurities to generate the mobile phase having the appropriate pH for the desired chromatography type and resin.

As an illustrative example, a solution containing the chemical element and one or more impurities in dilute HCl may be prepared (i.e. 0.01-5 N HCl). This may be applied to a solution packed, or dry, ion exchange column, and the chemical element (e.g. Lu-177) eluted with additional washes of dilute HCl. This is generally described by U.S. Pat. No. 7,244,403 as that the solution susceptible to treatment is generally a dilute solution of a strong acid, usually HCl. The bed of resin which may be in the form of a strong anion exchange resin in a column and the contacting occurs by flowing the solution through the column. In some embodiments, the resin is a strongly basic anion exchange resin which is about 8% cross linked. First, an HCl solution is flowed through the column to form an HCl-treated column, then flowing an NaCl solution through the HCl treated column to form an NaCl treated column, and then flowing sterile water through the NaCl-treated column. These preparative steps assist in eluting a sterile, nonpyrogenic product. The resin may then be dried prior to application of the lutetium solution. In some embodiments, the anion exchange resin is in a powdered form, generally having particles in the size of about 100 to about 200 mesh. To speed solution flow though the column, a sterile gas pressure may be applied to the head of the column. This can be carried out by injecting a sterile gas, preferably air, into an upper end of the column to push the solution of the chemical element (e.g. Lu-177) through the column. The chemical element recovered from such a process may be in a higher purity than prior to the column chromatography through the anion exchange column.

In some embodiments, a cation exchange resin may be used for the purification of the chemical element. As an illustrative example, and as generally described by U.S. Pat. No. 9,816,156, the method includes loading a first column packed with cation exchange material with the composition comprising the chemical element and one or more impurities dissolved in a mineral acid, exchanging the protons of the cation exchange material for ammonium ions, thereby using an NH₄Cl solution, and washing the cation exchange material of the first column with water. An outlet of the first column is linked with the inlet of a second column that is also packed with a cation exchange material. A gradient of water and a chelating agent is then applied to the column starting at 100% of FLO to 0.2M of the chelating agent on the inlet of the first column, so as to elute the lutetium from the first and second column. Illustrative examples of chelators include, but are not limited to, a-hydroxyisobutyrate [HIBA], citric acid, citrate, butyric acid, butyrate, EDTA, EGTA and ammonium ions. The method may also include determining the radioactivity dose on the outlet of the second column in order to recognize the elution of the chemical element (e.g. Lu-177). In some embodiments, a first eluate from the outlet of the second column in a vessel is collected, followed by protonating the chelating agent so as to inactivate same for the complex formation with the chemical element (e.g. Lu-177). The method may also include loading a final column packed with a cation exchange material by continuously conveying the acidic eluate to the inlet of the final column, washing out the chelating agent with diluted mineral acid of a concentration lower than approximately 0.1 M, removing traces of other metal ions from the lutetium solution by washing the cation exchange material of the final column with mineral acid of various concentrations in a range of approximately 0.01 to 2.5 M; and eluting the ions from the final column by way of a highly concentrated mineral acid of approximately 1M to 12M. The solvent and mineral acid can be removed from the collected eluate by vaporization.

In some embodiments, the chromatography comprises HPLC. HPLC is a chromatography technique that relies on pumps to pass a pressurized liquid solvent containing the sample mixture through a column. The column comprises an adsorbent material, such as silica particles, polymer particles, etc. The components of the mixture are separated from each other due to different degrees of interaction with the adsorbent material within the column. HPLC uses a smaller resin size and smaller adsorbent particles for the stationary phase compared to traditional, low pressure liquid chromatography, and thus achieves superior resolving power when separating mixtures.

The chromatographic separation (e.g. HPLC) may be conducted on an appropriate column and eluted with an appropriate mobile phase, each of which may change under different method development scenarios. For example, the column may be a cation exchange column, an anion exchange column, a reversed phase column, etc. and the mobile phase may be any suitable mobile phase determined to achieve separation of the desired components of a sample. The mobile phase may be aqueous- or organic solvent-based. Illustrative examples include, but are not limited to water, alcohols, alkanes, ethers, esters, acids, bases, and aromatics. In various embodiments, the mobile phase may include water, methanol/water, methanol/trifluoroacetic acid/water, and/or methanol mobile phase. In some embodiments, the chromatography is performed using a stationary phase containing particles such as silica particles, alumina particles, polymer particles, or a (C₁-C₁₈) derivatized reverse phase such as C₁-C₁₈, phenyl, pentafluorophenyl, C₁-C₁₈ alkyl-phenyl, or a polymer-based reversed phase. In some embodiments, the chromatography is performed using a mobile phase consisting of weather and 0-40% (vol.) of a water-miscible organic solvent. The organic solvent may be any one or more of methanol, ethanol, propanol, isopropanol, acetonitrile, acetone, N,N-dimethylformamide, dimethyl sulfoxide, or tetrahydrofuran. The solvent may also include the mobile phase further containing up to 10% (w/w) of an ion-pairing additive consisting of a cationic part and an anionic part. In some embodiments, the cationic part is H⁺, Li⁺, Na⁺, K⁺, Rb⁺, Cs⁺, NH₄⁺, or C₁-C₈ tetraalkylammonium. In some embodiments, the anionic part is F, Cl, Br, I, sulfate, hydrogen sulfate, nitrate, perchlorate, methanesulfonate, trifluoromethanesulfonate, (C₂-C₁₈ alkyl) sulfonate, formate, acetate, (C₂-C₁₈ alkyl) carboxylate, lactate, malate, citrate, 2-hydroxyisobutyrate, mandelate, diglycolate, or tartarate.

In some embodiments, the chromatographic separation may be achieved using HPLC on a C₈, C₁₈, or phenyl-hexyl reversed phase. In some embodiments, a mobile phase may be used that is water and 3-40 vol % of methanol, ethanol, or acetonitrile. Optionally, 0.01-0.1 mol/L of a buffer may be used in the mobile phase. Exemplary buffers include sodium acetate (e.g. sodium acetate pH=4.5), ammonium formate (e.g. ammonium formate pH=7.00), or ammonium acetate (e.g. ammonium acetate pH=7.0).

In some embodiments, the methods provided herein involve chelating the composition and/or the semi-purified sample. For example, in some embodiments the methods comprise chelating the composition comprising the chemical element and one or more impurities, and performing chromatography on the chelated composition to remove a portion of the one or more impurities, thereby obtaining the semi-purified sample. As another example, in some embodiments the methods comprise subjecting the composition comprising the chemical element and one or more impurities to sublimation/distillation to remove a portion of the one or more impurities, and subsequently chelating the semi-purified sample prior to performing one or more subsequent chromatographic separation steps. In some embodiments, a sample is chelated during some chromatographic separation steps and not during others. For example, in some embodiments the method comprises performing at least two chromatographic separation steps after removing at least a portion of the one or more impurities from the composition comprising the chemical element and the one or more impurities by chromatography, sublimation, or distillation, and during the first of such two chromatographic separation steps the sample is chelated and during the second of such two chromatographic separation steps the sample is not chelated. In some embodiments, the sample is chelated and a metal dopant is added to the sample. For example, in some embodiments the semi-purified sample is chelated and then a metal dopant is added to the sample. As another example, in some embodiments a metal dopant is added to semi-purified sample, and then the semi-purified sample containing the metal dopant is chelated. In some embodiments, following chromatographic separation a sample is de-chelated. For example, in some embodiments following chromatographic separation the sample fraction enriched in the chemical element is de-chelated.

In some embodiments, chelating a sample comprises dissolving the sample in an acid to form a dissolved solution, adding a chelator to the dissolved solution, and neutralizing with a base to form a chelated solution. In some embodiments, the chemical element, the one or more impurities, and/or the metal dopant are chelated following such a process. For example, in some embodiments the chemical element and the one or more impurities are chelated following such a process. In some embodiments, the chemical element, the one or more impurities, and the metal dopant are chelated following such a process. The initial dissolution in an acid of the lutetium may be conducted using an acid such as hydrofluoric acid, hydrochloric acid, hydrobromic acid, hydroiodic acid, sulfuric acid, nitric acid, peroxosulfuric acid, perchloric acid, methanesulfonic acid, trifluoromethanesulfonic acid, formic acid, acetic acid, trifluoroacetic acid, or a mixture of any two or more thereof. The concentration of the acid may be from about 0.01 M to about 6 M. This includes concentrations of about 1 M to about 6 M and about 2 M to about 6 M. In some embodiments, the chelator is then added along with a base (e.g. lithium hydroxide, sodium hydroxide, potassium hydroxide, NH⁴OH, or an alkylammonium hydroxide) to neutralize the acid and produce the chelated chemical element. In some embodiments, the concentration of the base is from about 0.01 M to about 6 M.

In some embodiments, following chelation a chromatographic separation step is conducted. In some embodiments, a chromatographic separation step is conducted on a semi-purified sample comprising a metal dopant. In some embodiments, the chemical element in the semi-purified sample is chelated. In some embodiments, the chemical element and the metal dopant are chelated. For example, in some embodiments following chelation HPLC is conducted on the semi-purified, chelated sample comprising the metal dopant. In some embodiments, following one or more chromatographic separation steps the sample is then de-chelated. In some embodiments, the de-chelating includes contacting a sample (e.g. the sample fraction enriched in the chemical element) with an acid, such as hydrofluoric, hydrochloric, hydrobromic, hydroiodic, sulfuric, nitric, peroxosulfuric, perchloric, methanesulfonic, trifluoromethanesulfonic, formic, acetic, or trifluoroacetic acid, or a mixture of any two or more thereof. In some embodiments, the decomplexation/de-chelation is achieved by using HCl (0.01-12 mol/L) at 25° C. to 95° C. for time period of 5 minutes to 24 hours.

The methods described herein find use in purification of any desired chemical element (e.g. radioisotope) of interest. In some embodiments, the chemical element comprises lutetium. In some embodiments, the chemical element comprises Lu-177. In some embodiments, the chemical element comprises Lu-177 and the one or more impurities comprise ytterbium. In some embodiments, the chemical element comprises rubidium (e.g. rubidium-82), thallium (thallium-201), fluorine (fluorine-18), iridium (iridium-192), palladium (palladium-103), strontium (e.g. strontium-89), rhenium (e.g. rhenium-186), bismuth (bismuth-213), boron (e.g. boron-10), gadolinium (e.g. gadolinium-157), caesium (caesium-131), yttrium (e.g. yttrium-90), iodine (e.g. iodine-131, iodine-125), samarium (e.g. samarium-153), astatine (e.g. astatine-211), lead (e.g. lead-212), radium (e.g. radium-223), actinium (e.g. actinium-225), thorium (e.g. thorium-227), molybdenum (e.g. molybdenum-99), technetium (e.g. technetium-99), terbium (e.g. terbium-149, terbium-152, terbium-155, terbium-161), xenon (e.g. xenon-133), cobalt (e.g. cobalt-60), or phosphorus (e.g. phosphorus-32).

In some embodiments, the methods provided herein achieve greater than 99% purity of the chemical element following purification on an isotopic basis. In some embodiments, the methods provided herein achieve greater than 99.9%, greater than 99.99%, greater than 99.999%, greater than 99.9999%, or greater than 99.99999% purity of the chemical element following purification on an isotopic basis. For example, in some embodiments the methods provided herein achieve purified Lu-177 that is greater than 99% pure on an isotopic basis. This includes Lu-177 that is greater than 99.9%, greater than 99.99%, greater than 99.999%, or greater than 99.9999% pure on an isotopic basis. Moreover, the one or more impurities can be collected (e.g. following sublimation, following distillation, following chromatographic separation) and recycled. For example, in a composition comprising lutetium and ytterbium, the ytterbium can be collected and recycled, such as for future generation of Lu-177 by irradiation.

In some aspects, provided herein are systems comprising a composition comprising a chemical element and one or more impurities; one or more chromatography resins; and a radical scavenger and/or a metal dopant. Such a system finds use in a method of purifying the chemical element, as described herein, while minimizing radiolytic loss of the chemical element during purification.

In some embodiments, the chemical element comprises lutetium. In some embodiments, the chemical element comprises Lu-177. In some embodiments, the system comprises a chemical element described above, such as rubidium (e.g. rubidium-82), thallium (thallium-201), fluorine (fluorine-18), iridium (iridium-192), palladium (palladium-103), strontium (e.g. strontium-89), rhenium (e.g. rhenium-186), bismuth (bismuth-213), boron (e.g. boron-10), gadolinium (e.g. gadolinium-157), caesium (caesium-131), yttrium (e.g. yttrium-90), iodine (e.g. iodine-131, iodine-125), samarium (e.g. samarium-153), astatine (e.g. astatine-211), lead (e.g. lead-212), radium (e.g. radium-223), actinium (e.g. actinium-225), thorium (e.g. thorium-227), molybdenum (e.g. molybdenum-99), technetium (e.g. technetium-99), terbium (e.g. terbium-149, terbium-152, terbium-155, terbium-161), xenon (e.g. xenon-133), cobalt (e.g. cobalt-60), or phosphorus (e.g. phosphorus-32).

The system may comprise a chromatography resin suitable for any chromatography type, column chromatography, thin cell chromatography, plate chromatography, etc. In some embodiments, the system comprises one or more anion exchange resins, one or more cation exchange resins, and/or one or more high performance liquid chromatography resins. In some embodiments, the system comprises one or more fluids (e.g. gases, liquids) or buffers useful for the chromatography type. Suitable chromatography fluids (e.g. solvents, buffers, water, etc.) are described above. For example, in some embodiments the system comprises an aqueous- or organic solvent-based fluid, such as one containing water, alcohols, alkanes, ethers, esters, acids, bases, or aromatics.

In some embodiments, the metal dopant comprises lanthanum, cerium, praseodymium, neodymium, promethium, samarium, europium, gadolinium, terbium, dysprosium, holmium, erbium, thulium, ytterbium, or a salt thereof.

In some embodiments, the system comprises a chelator. In some embodiments, the system comprises one or more components for chelating and/or de-chelating the chemical element (e.g. radioisotope), including suitable acids and/or bases described above.

In some embodiments, the system is contained in a hot cell.

The present invention, thus generally described, will be understood more readily by reference to the following examples, which are provided by way of illustration and are not intended to be limiting of the present invention.

### EXAMPLES

### Example 1

Radiolytic loss during chromatographic separation results in decreased efficiency of current purification techniques for radioisotopes such as Lu-177. In particular, high levels of radiolytic loss (greater than 25%) can be seen during a first chromatographic separation step after an initial removal of a large portion of impurities, such as ytterbium, from the sample. Accordingly, experiments were conducted herein develop effective strategies to mitigate radiolytic loss. Specifically, lanthanum chelate was added to the sample to determine whether the presence of a sacrificial metal dopant would reduce radiolytic loss.

Samples comprising ytterbiun (Yb-176) and lutetium (Lu-177) were first subjected to an initial purification step (referred to as stage 1) to remove a large portion of the ytterbium from the sample. Stage 1 purification can be by sublimation, distillation, or chromatography. Following stage 1, lanthanum chelate (50 mg) was added to the sample, and chromatographic separation was conducted (referred to as stage 2). As a control, samples were subjected to stage 1 purification and subsequent chromatography (stage 2) without addition of lanthanum chelate. Results are shown in Table 1.

TABLE 1
Radiolysis Mitigation by Lanthanum Chelate

| | | Relative Activity in | Radiolysis |
|---|---|---|---|
| Injection ID | Radiolysis Mitigator | Injection | Loss (%) |
| 1 | None | 1.00 | 23.96 |
| 2 | None | 1.19 | 27.04 |
| 3 | La Chelate | 2.57 | 13.69 |
| 4 | La Chelate | 1.16 | 9.71 |

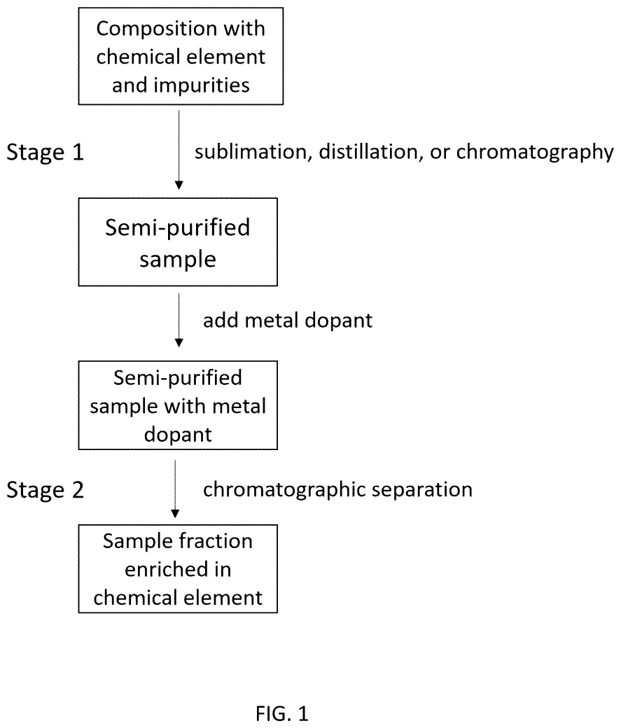

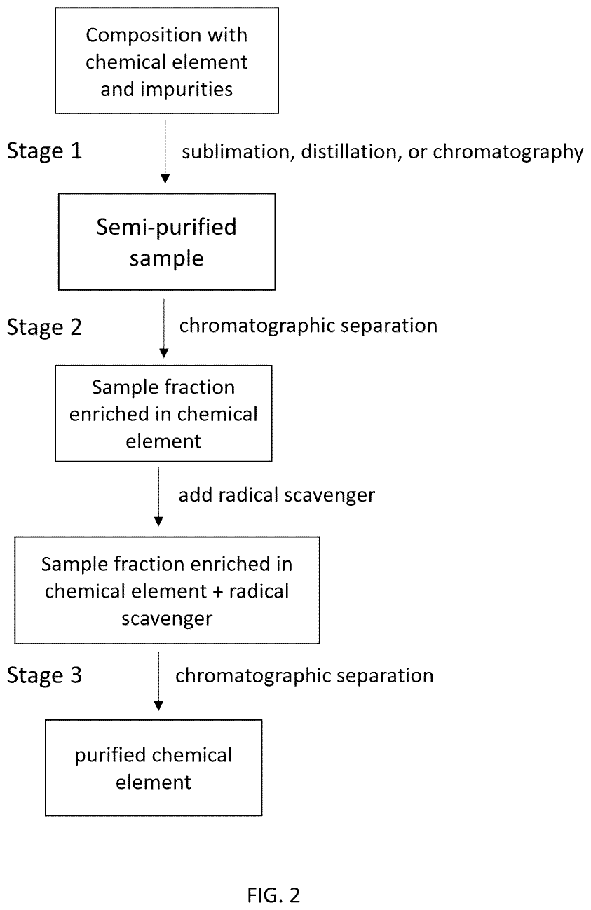

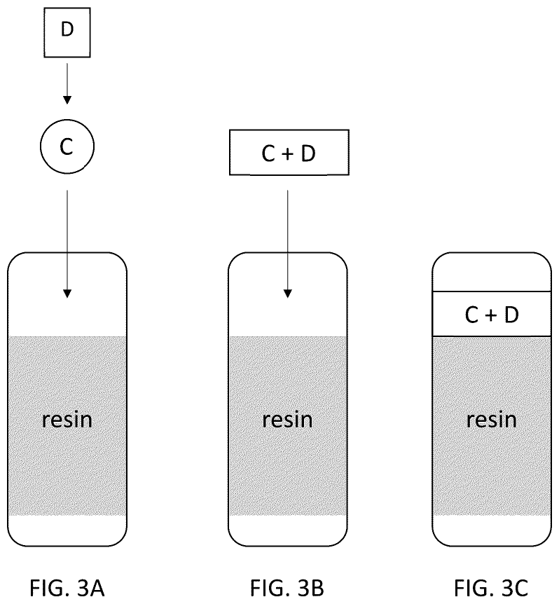

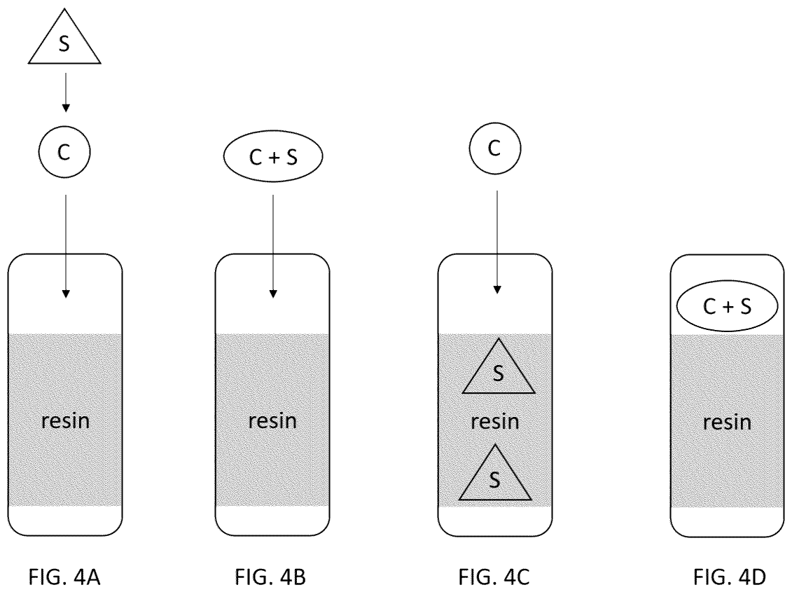

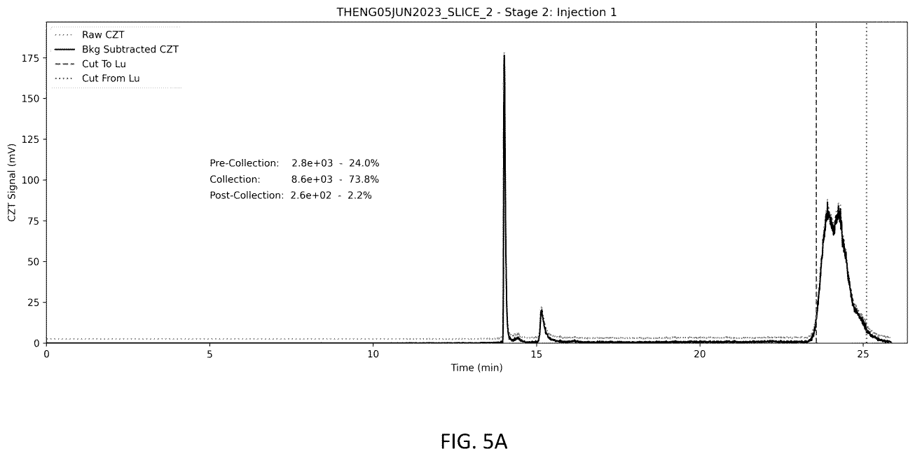

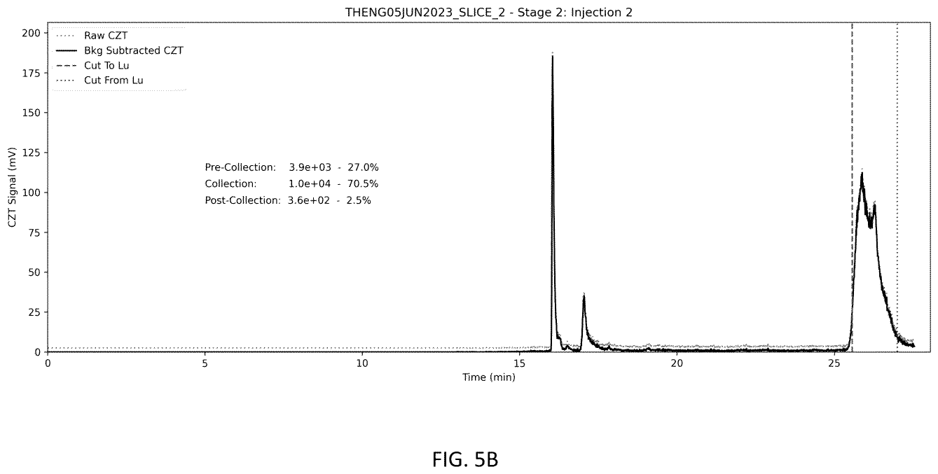

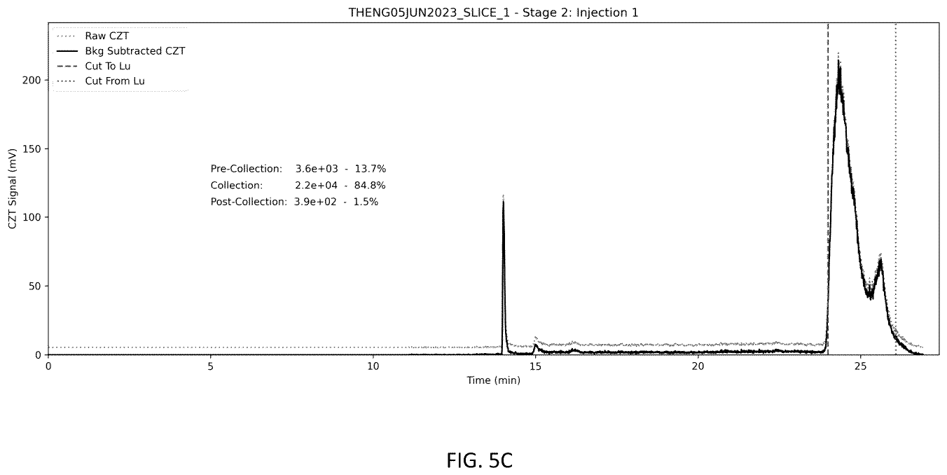

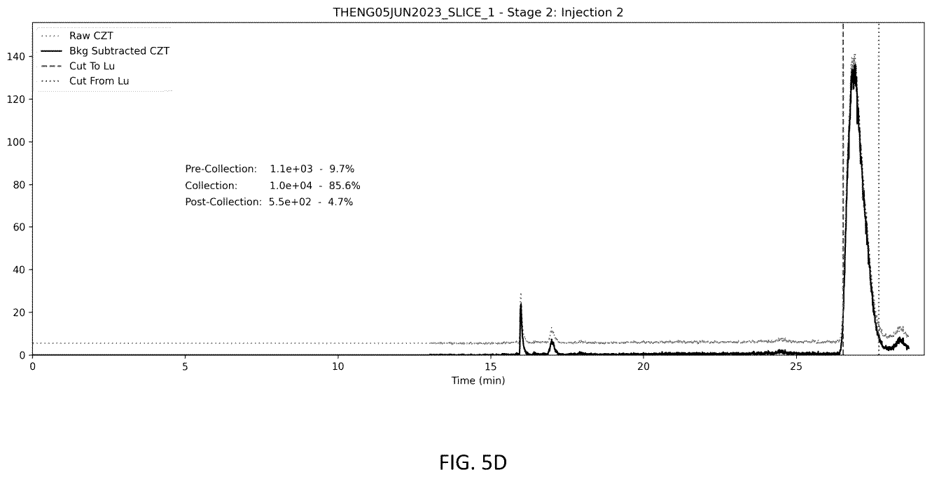

As shown, the addition of lanthanum chelate significantly reduces the radiolytic loss seen in stage 2. Similar injection activities for injection 1 and injection 2 (without radiolysis mitigator) and injection 4 (with lanthanum chelate) show a 2.5× decrease in radiolytic loss in the presence of the lanthanum chelate. Furthermore, over double the injection activity in row 3 still shows about a 2× decrease in radiolytic loss. Graphs showing injection activity for injections 1, 2, 3, and 4 are shown in FIGS. 1A, 1B, 1C, and 1D, respectively.

To confirm that lanthanum chelate does not contaminate the final purified sample, Lu-177 was collected following stage 2 and analyzed by IPC-MS. Results show that lanthanum is not present in appreciate levels in the purified product. A first experiment revealed that lanthanum was only present in less than 10 parts per billion (ppb) in the purified Lu-177 product, and a second experiment demonstrated that lanthanum was only present at 58 bbp in the purified Lu-177 product.

Taken together, these results demonstrate that a sacrificial metal dopant, such as lanthanum, mitigates radiolytic loss during chromatographic separation of Lu-177 without causing notable levels of contamination in the purified product.

### Example 2

In some methods of purifying radioisotopes such as Lu-177, multiple chromatographic separation steps are used. Radiolytic loss can occur during any separation step, and as such additional techniques to mitigate radiolytic loss were investigated herein.

In some methods provided herein, an initial purification step (stage 1), such as chromatography, distillation, or sublimation is performed to remove a large portion of impurities from the sample. The sample is then subjected to chromatography (stage 2). To further enrich for the desired chemical element, an additional chromatography step can be conducted (stage 3). Example 1 demonstrates that addition of a metal dopant such as lanthanum chelate prior to stage 2 effectively mitigates radiolysis. However, radiolytic loss can also be observed during stage 3. To mitigate this loss, the radical scavenger sodium ascorbate was added to the sample after stage 2, prior to stage 3 chromatography. A direct comparison of samples containing sodium ascorbate and samples not contacting sodium ascorbate during stage 3 chromatography was performed. Results are shown in Table 2.

TABLE 2
Radiolysis Mitigation by Sodium Ascorbate

| | | Relative Activity in | Radiolytic |
|---|---|---|---|
| Injection ID | Radiolysis Mitigator | injection | Loss (%) |
| 1 | None | 0.37 | 19.04 |
| 2 | None | 1.00 | 18.44 |
| 3 | None | 1.02 | 13.76 |
| 4 | None | 0.55 | 13.70 |
| 5 | Sodium ascorbate | 0.45 | 3.30 |
| 6 | Sodium ascorbate | 1.04 | 8.33 |
| 7 | Sodium ascorbate | 1.22 | 12.68 |
| 8 | Sodium ascorbate | 0.65 | 6.72 |

As shown, sodium ascorbate confers notable protection against radiolysis. A comparison of similar injection activities, such injections 2 and 3 with no radiolysis mitigator and injection 6 with sodium ascorbate, show a 1.5-2× decrease in radiolytic loss when sodium ascorbate is present during stage 3 purification.

What is claimed is:

1. A method for purifying a chemical element, the method comprising:
a) subjecting a composition comprising the chemical element and one or more impurities to sublimation, distillation, or chromatography, thereby removing at least a portion of the one or more impurities from the composition to obtain a semi-purified sample;
b) adding a metal dopant to the semi-purified sample; and
c) subjecting the semi-purified sample containing the metal dopant to chromatographic separation to remove the metal dopant and other impurities, thereby obtaining a sample fraction enriched in the chemical element.

2. The method of claim 1, wherein the metal dopant comprises lanthanum, cerium, praseodymium, neodymium, promethium, samarium, europium, gadolinium, terbium, dysprosium, holmium, erbium, thulium, ytterbium, or a salt thereof.

3. The method of claim 2, wherein the metal dopant is chelated.

4. The method of claim 1, wherein the amount of the metal dopant added to the semi-purified sample exceeds the amount of the chemical element in the sample.

5. The method of claim 1, further comprising chelating the semi-purified sample comprising the metal dopant prior to the chromatographic separation, and de-chelating the sample fraction enriched in the chemical element following the chromatographic separation.

6. The method of claim 1, further comprising subjecting the sample fraction enriched in the chemical element to an additional chromatographic separation step to further enrich for the chemical element.

7. The method of claim 6, comprising adding a radical scavenger to the sample fraction enriched in the chemical element prior to the additional chromatographic separation step.

8. The method of claim 6, wherein the sample fraction enriched in the chemical element is not chelated during the additional chromatographic separation step.

9. The method of claim 8, wherein the chemical element is lutetium.

10. The method of claim 1, wherein the chemical element is a radioisotope.

11. The method of claim 1, wherein the one or more impurities comprise ytterbium.

12. A method for purifying a chemical element, the method comprising:
a) subjecting a composition comprising the chemical element and one or more impurities to sublimation, distillation, or chromatography, thereby removing at least a portion of the one or more impurities from the composition to obtain a semi-purified sample;
b) subjecting the semi-purified sample to a chromatographic separation, thereby obtaining a sample fraction enriched in the chemical element; and
c) contacting the sample fraction enriched in the chemical element with a radical scavenger and subjecting the sample fraction and the radical scavenger to an additional chromatographic separation to remove the radical scavenger and other impurities.

13. The method of claim 12, further comprising chelating the semi-purified sample prior to the chromatographic separation and de-chelating the sample fraction enriched in the chemical element following the chromatographic separation.

14. The method of claim 12, wherein the sample fraction containing the radical scavenger is not chelated during the additional chromatographic separation.

15. The method of claim 12, wherein the chemical element is lutetium.

16. The method of claim 12, wherein the chemical element is a radioisotope.

17. The method of claim 12, wherein the one or more impurities comprise ytterbium.

18. A system comprising:
a) a composition comprising lutetium and one or more impurities;
b) one or more chromatography resins; and
c) a radical scavenger and/or a metal dopant.

19. The system of claim 18, wherein the metal dopant comprises lanthanum, cerium, praseodymium, neodymium, promethium, samarium, europium, gadolinium, terbium, dysprosium, holmium, erbium, thulium, ytterbium, or a salt thereof.

20. The system of claim 18, wherein the system is contained in a hot cell.
